(19) United States
(12) Patent Application Publication
(10) Pub. No.: US 2026/0338923 A1
(43) Pub. Date: Oct. 29, 2026

(54) CIRCUMFERENTIAL SCANNING METHOD OF LIDAR DEVICE

(71) Applicant: AUTOX TECH PTE. LTD., SINGAPORE (SG)

(72) Inventors: Yizhou Shan, Shenzhen (CN); Jianxiong Xiao, Shenzhen (CN); Kefan Hu, Shenzhen (CN); Xuhui Tao, Shenzhen (CN); Wenxiang Wang, Shenzhen (CN)

(73) Assignee: AUTOX TECH PTE. LTD., SINGAPORE (SG)

(21) Appl. No.: 19/193,876

(22) Filed: Apr. 29, 2025

(51) Int. Cl. G01S 7/481; G01S 17/89

(52) U.S. Cl. CPC G01S 7/4817; G01S 17/89

(57) ABSTRACT

The disclosure provides a circumferential scanning method for a LiDAR device including a laser transceiver assembly, configured to transmit and receive laser beams; and a reflecting element, including a polygon mirror through which an optical path of the laser transceiver assembly passes. The method includes splitting an emitted beam from the laser transceiver assembly into a plurality of parallel emitted beams propagating along a predetermined first direction in a plane parallel to a first axis; synchronously rotating the reflecting element about the first axis, and inverting the polygon mirror about a second axis perpendicular to the first axis, in order to either: reflect the parallel emitted beams via the polygon mirror as outgoing beams, or reflect incoming beams, formed by reflection of the outgoing beams from an object, via the polygon mirror as parallel reflected beams in the plane; and receiving the parallel reflected beams at the laser transceiver assembly.

### TECHNICAL FIELD

The disclosure relates to the technical field of LiDAR devices, and in particular, to a circumferential scanning method for a LiDAR device.

### BACKGROUND

The essence of laser three-dimensional imaging is parallel laser ranging, which obtains a target's distance image based on the time difference between directly or indirectly acquired laser transmitted signals and echo signals. A scanning LiDAR device is composed of a single-point laser coherent or non-coherent ranging system equipped with a beam scanning device, which is a relatively mature three-dimensional imaging LiDAR device technology currently developed. The scanning LiDAR device requires rapid ranging for each point, with the beam scanning device controlling the direction of the radar's optical axis to measure the distance of each point on the target in sequence, while recording the azimuth-elevation angle of the beam pointing, thereby obtaining the target's distance-angle-angle image.

Vehicle-mounted LiDAR devices that provide necessary 3D point cloud data for driverless vehicles usually require a 360° horizontal field of view and a certain vertical field of view. Scanning LiDAR devices utilize motor-driven mirror rotation and geometric optics principles to achieve beam deflection, featuring large scanning fields of view and high scanning efficiency. They are the most common, widely applied, and mature vehicle-mounted LiDAR devices in recent years. “Mechanical rotation+linear array transceiver arrangement” is a typical representative of this scanning method: mechanical rotation is employed in the horizontal direction to obtain a 360° field of view; in the vertical direction, a linear array arrangement of laser transceiver modules and a matching parallel detection module are used to form multi-line scanning in a plane perpendicular to the linear array arrangement direction. There are specific angles between the individual scanning beams, achieving uniform or non-uniform angular coverage to a certain extent in the line arrangement direction. This scanning method reduces the motion in one dimension, requiring scanning along only one dimension to acquire the target's distance image, significantly improving the system's scanning efficiency. However, this solution requires high-frequency laser emission sources to be densely arranged in a vertical array in the upper housing structure of the scanning LiDAR device, with precise alignment of optical modules for transmission and reception in each channel. The crosstalk between different ranging channels results in high assembly and installation precision requirements, large overall size, large moment of inertia, high power consumption, and high cost for the scanning LiDAR device, as well as high requirements for heat dissipation and technology.

### SUMMARY

The disclosure provides a circumferential scanning method for a LiDAR device, solving the problems of large overall size, large moment of inertia, high power consumption, and high cost in scanning LiDAR devices.

The disclosure provides circumferential scanning method for a LiDAR device. The LiDAR device includes a laser transceiver assembly and a reflecting element including a polygon mirror, the laser transceiver assembly being configured to transmit and receive laser beams, the reflecting element being rotatable about a first axis, and the polygon mirror being invertible about a second axis, the first axis and the second axis being perpendicular to each other, and an optical path of the laser transceiver assembly passing through the polygon mirror; circumferential scanning method comprises: splitting a emitted beam from the laser transceiver assembly to form a plurality of parallel emitted beams transmitted along a predetermined first direction and in a plane, the plane being parallel to the first axis; rotating the reflecting element and inverting the polygon mirror synchronously to either: reflect the parallel emitted beams via the polygon mirror to form reflected beams exiting the LiDAR device, or reflect incoming reflected beams, formed by reflection of the reflected beams from an object, via the polygon mirror to form parallel reflected beams within the plane; and receiving the parallel reflected beams by the laser transceiver assembly.

In the above circumferential scanning method for a LiDAR device, a emitted beam is split to form the parallel emitted beams. Through cooperation between the reflecting element rotatable about the first axis and the polygon mirror invertible about the second axis, when the parallel emitted beams is incident on the polygon mirror, the polygon mirror reflects the parallel emitted beams along the first axis and the second axis by rotating about the first axis while inverting about the second axis, thereby achieving multi-line scanning. The polygon mirror can achieve 360° circumferential scanning of the LiDAR device by rotating 360° about the first axis while inverting 360° about the second axis, forming a 360° point cloud array. Based on the emitted beam and the incoming reflected beams, and synchronized with the angles of rotation and inversion of the polygon mirror, 360° point cloud data can be obtained. The overall structure of the LiDAR device breaks through the constraints of the traditional upper and lower housing structure configuration of multi-line LiDAR devices, making it applicable to LiDAR devices of different systems including non-coherent and coherent systems. It has a small moment of inertia, simple structure, high reliability, and easy integration and miniaturization, showing good development prospects in the field of vehicle-mounted LiDAR devices.

### BRIEF DESCRIPTION OF THE DRAWINGS

To more clearly illustrate the technical solutions in the embodiments of the disclosure or in the prior art, the following provides a brief introduction to the drawings required for describing the embodiments or the prior art. It is apparent that the drawings described below are merely some embodiments of the disclosure. For those skilled in the art, other drawings can be obtained based on the structures shown in these drawings without exercising inventive effort.

FIG. 1 is a schematic diagram of a LiDAR device in accordance with an embodiment.

FIG. 2 is a schematic diagram of the internal structure of the LiDAR device in accordance with an embodiment.

FIG. 3 is a schematic diagram of the internal structure of the laser transceiver assembly of the LiDAR device shown in FIG. 1.

FIG. 4 is a schematic diagram of the laser transceiver assembly of the LiDAR device shown in FIG. 1.

FIG. 5 is a schematic diagram of the internal structure of the reflecting element of the LiDAR device shown in FIG. 1.

FIG. 6 is a cross-sectional schematic diagram of the polygon mirror of the LiDAR device shown in FIG. 1.

FIG. 7 is a schematic diagram of the internal structure of the processing assembly of the LiDAR device shown in FIG. 1.

FIG. 8 is a diagram showing the connection relationship between the processing assembly and the laser transceiver assembly of the LiDAR device shown in FIG. 1.

FIG. 9 is a flowchart of the method for realizing circumferential scanning of the LiDAR device in accordance with an embodiment.

The realization of the objectives, functional characteristics, and advantages of the disclosure will be further described below with reference to the embodiments and the drawings.

### DETAILED DESCRIPTION OF THE EMBODIMENTS

In order to make the purpose, technical solution, and advantages of this application clearer and clearer, the following will provide further detailed explanations of this application in conjunction with the accompanying drawings and embodiments. It should be understood that the specific embodiments described here are only intended to explain the present application and are not intended to limit the present application. Based on the embodiments in this application, all other embodiments obtained by ordinary technical personnel in this field without creative labor fall within the scope of protection of this application.

The terms “first,” “second,” “third,” “fourth,” etc. (if present) in the specification, claims, and accompanying drawings of the present application are used to distinguish similar planning objects and are not necessarily used to describe a specific sequence or order. It should be understood that such terms, when used, may be interchangeable under appropriate circumstances. In other words, the described embodiments may be implemented in an order other than that illustrated or described herein. Furthermore, the terms “include” and “have” and any variations thereof may also encompass additional content. For example, a process, method, system, product, or device comprising a series of steps or units is not limited to only those steps or units clearly listed but may include other steps or units not clearly listed or inherent to those processes, methods, products, or device.

It is important to note that the descriptions involving “first,” “second,” etc., in the present application are solely for descriptive purposes and should not be understood as indicating or implying their relative importance or implicitly specifying the number of indicated technical features. Therefore, features qualified by “first,” “second,” etc., may explicitly or implicitly include one or more of such features. In addition, the technical solutions among the various embodiments may be combined with each other, but this must be based on the ability of ordinary skilled artisans in the field to achieve such combinations. When the combination of technical solutions contradicts each other or cannot be implemented, such combinations should be deemed non-existent and not within the scope of protection claimed in the present application.

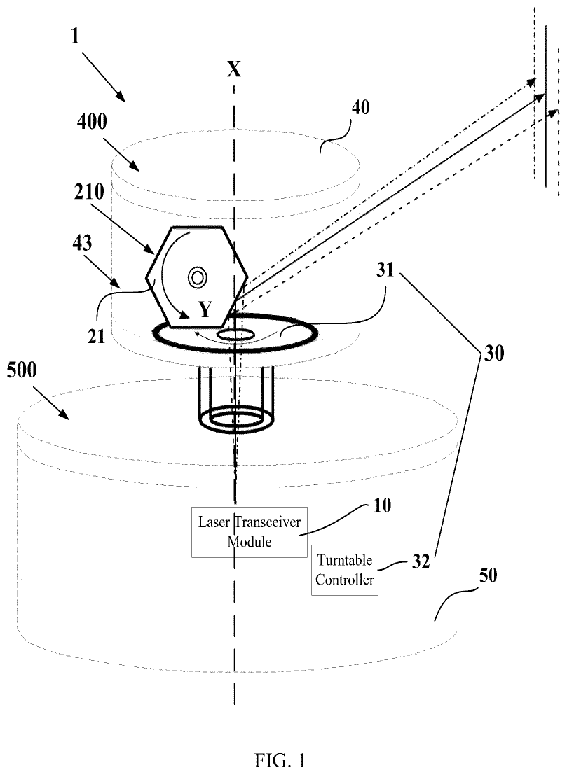

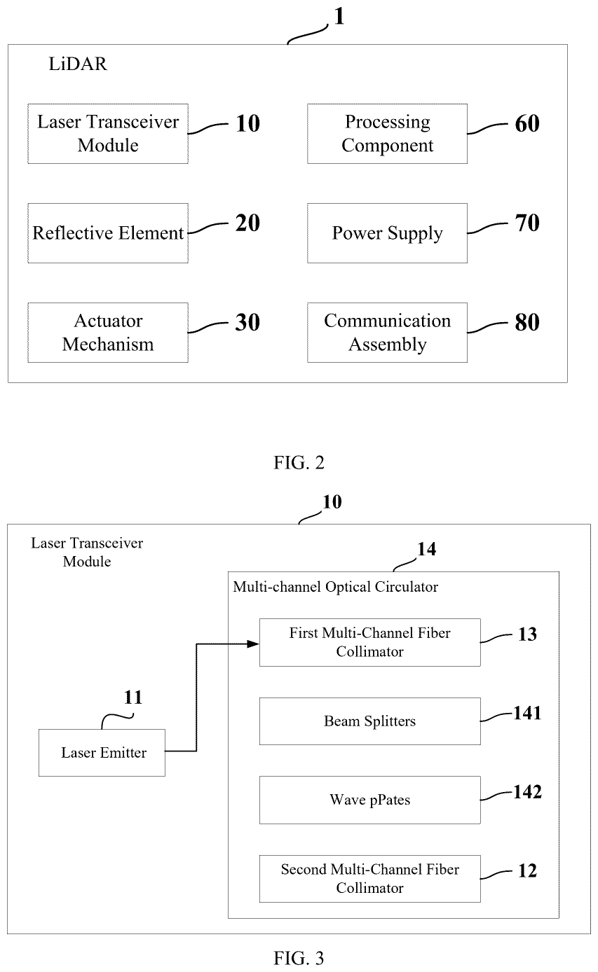

Referring to FIGS. 1 to 3, FIG. 1 is a schematic diagram of a LiDAR device in accordance with an embodiment, FIG. 2 is a schematic diagram of the internal structure of the LiDAR device in accordance with an embodiment, and FIG. 3 is a schematic diagram of the laser transceiver assembly in accordance with an embodiment. The LiDAR device 1 includes an upper housing 40, a lower housing 50, a connecting neck 90, and an optical path 100. In this embodiment, the upper housing 40 and the lower housing 50 are arranged opposite each other, and the connecting neck 90 connects the upper housing 40 and the lower housing 50, and is located between the upper housing 40 and the lower housing 50. The optical path 100 passes through the upper housing 40, the connecting neck 90, and the lower housing 50. The LiDAR device 1 further includes a laser transceiver assembly 10, a reflective assembly 20, and a actuator mechanism 30. The laser transceiver assembly 10 is disposed inside the lower housing 50, and the reflective assembly 20 is disposed inside the upper housing 40.

Furthermore, the upper housing 40 includes a cylindrical first shell 41, the lower housing 50 includes a cylindrical second shell 51, and the connecting neck 90 includes a cylindrical third shell 91. The central axes of the first shell 41, the second shell 51, and the third shell 91 all coincide. That is, the upper housing 40, the lower housing 50, and the connecting neck 90 are all cylindrical. In this embodiment, the diameters of the first shell 41 and the second shell 51 are approximately the same and larger than the diameter of the connecting neck 90, so the overall shape of the LiDAR device 1 is roughly I-shaped.

The upper housing 40 includes a window 43. The window 43 is disposed on the side of the first shell 41. Furthermore, the window 43 is an annular window. Specifically, in this embodiment, the first shell 41 and the second shell 51 are spaced apart along the first axis X and fixedly connected by the connecting neck 90. The first shell 41 is provided with a first accommodating cavity 400, the second shell 51 is provided with a second accommodating cavity 500, and the first accommodating cavity 400 and the second accommodating cavity 500 are in communication. It can be understood that the optical path 100 passes through the first accommodating cavity 400 and the second accommodating cavity 500, and the axes of the first shell 41, the second shell 51, and the first axis X are parallel.

In this embodiment, the actuator mechanism 30 includes a turntable 31 and a turntable controller 32 that are electrically connected. The turntable controller 32 is fixed inside the lower housing 50, one end of the turntable 31 is connected to the turntable controller 32, and the other end of the turntable 31 extends into the upper housing 40 for installing the reflective assembly 20. That is, the turntable controller 32 is accommodated in the second accommodating cavity 500, one end of the turntable 31 is connected to the turntable controller 32, and the other end of the turntable 31 protrudes into the first accommodating cavity 400. The reflective assembly 20 is fixed to the turntable 31, and the turntable controller 32 is used to control the turntable 31 to rotate about the first axis X. The direction of rotation includes clockwise and counterclockwise rotation. It can be understood that since the reflective assembly 20 is fixed to the turntable 31, when the turntable controller 32 controls the turntable 31 to rotate about the first axis X, the reflective assembly 20 rotates with the turntable 31. That is, the reflective assembly 20 is rotatable about the first axis X.

In this embodiment, the first axis X is the central axis of the turntable 31. The turntable 31 includes a rotating shaft 311, and a rotating disk 312, and the rotating shaft 311 connects the turntable controller 32 and the rotating disk 312 respectively. The rotating shaft 311 is in the shape of a hollow cylinder, and the first axis X is the central axis of the rotating shaft 311. The reflective assembly 20 is disposed on the side of the rotating disk 312 away from the turntable controller 32. Furthermore, the first axis X coincides with the central axes of the first shell 41, the second shell 51, and the third shell 91. In this embodiment, the turntable controller 32 can control the turntable 31 to rotate 360° about the first axis X, enabling the LiDAR device 1 to achieve 360° circumferential linear array laser scanning. A rotation speed of the turntable 31 when rotating about the first axis X under the control of the turntable controller 32 is a first rotation speed, which can be set according to actual application scenarios. The higher the first rotation speed of the turntable 31, the faster the LiDAR device 1 perceives the external environment.

The reflective assembly 20 is accommodated in the first accommodating cavity 400, and includes a polygon mirror 21 and a self-rotation controller 22. The polygon mirror 21 is invertible about a second axis Y. Specifically, the polygon mirror 21 is mounted on the turntable 31, and the self-rotation controller 22 is used to drive the polygon mirror 21 to invert about the second axis Y, which is different from the direction of the first axis X, on the turntable 31. It can be understood that the polygon mirror 21 can rotate with the turntable 31, i.e., rotate about the first axis X; the entire polygon mirror 21 can also invert about the second axis Y, and the rotation speed about the first axis X is the same as the first rotation speed of the turntable 31. Therefore, the polygon mirror 21 can invert about the second axis Y while rotating about the first axis X. The direction of inversion includes clockwise and counterclockwise inversion. Furthermore, the self-rotation controller 22 controls the polygon mirror 21 to invert 360° about the second axis Y. The inversion speed of the polygon mirror 21 when inverting about the second axis Y under the control of the self-rotation controller 22 is a second rotation speed, which can be set according to actual application scenarios. The higher the second rotation speed of the polygon mirror 21, the faster the LiDAR device 1 perceives the external environment.

There is an angle between the second axis Y and the first axis X, and the size of the angle can be set according to actual conditions. In this embodiment, the first axis X and the second axis Y are perpendicular to each other, i.e., the angle between the second axis Y and the first axis X is 90°.

The polygon mirror 21 includes but is not limited to a prism or a pyramid, etc. In this embodiment, the polygon mirror 21 is a regular prism, and the second axis Y is the central axis of the polygon mirror 21. It can be understood that when the polygon mirror 21 rotates about the first axis X, the second axis Y rotates with the polygon mirror 21. That is, the second axis Y is not fixed. The regular prism includes but is not limited to a regular hexagonal prism, a regular octagonal prism, etc. In some feasible embodiments, the polygon mirror 21 can also be a pyramid. Regardless of whether the polygon mirror 21 is a regular prism or a pyramid, all sides of the polygon mirror 21 are reflecting mirrors, and the sides of the polygon mirror 21 can reflect light beams to deflect them. Disposing only the reflective assembly 20 in the first accommodating cavity 400 can reduce the overall weight of the components placed in the first accommodating cavity 400, making the turntable 31 lighter in weight during rotation, and thus rotating more lightly. At the same time, it can also reduce the adverse effects of vibration and displacement on the components caused by the rotation of the turntable 31.

The polygon mirror 21 includes a plurality of reflecting surfaces 210, and the plurality of reflecting surfaces 210 are adjacent to each other around the second axis Y. It can be understood that each reflecting surface 210 is parallel to the second axis Y.

The laser transceiver assembly 10 is used to transmit and receive laser light, and the optical path of the laser transceiver assembly 10 passes through the polygon mirror 21. In this embodiment, the laser transceiver assembly 10 is accommodated in the second accommodating cavity 500.

In this embodiment, the laser transceiver assembly 10 includes a laser transmitter 11 and a multi-channel optical circulator 14. The laser transmitter 11 is a laser emission source and can emit frequency-modulated continuous wave laser or pulsed wave laser. The multi-channel optical circulator 14 forms a plurality of transmitting channels and a plurality of receiving channels. The number of transmitting channels is the same as the number of receiving channels, and the transmitting channels and receiving channels are in one-to-one correspondence. The multi-channel optical circulator 14 includes a first multi-channel fiber collimator 13 and a second multi-channel fiber collimator 12. The number of channels of the first multi-channel fiber collimator 13 is the same as the number of channels of the second multi-channel fiber collimator 12. The laser transmitter 11 is connected to the first multi-channel fiber collimator 13.

Referring to FIG. 9, which is a flowchart of the method for realizing circumferential scanning of the LiDAR device provided in this embodiment. The method for realizing circumferential scanning of the LiDAR device specifically includes the following steps.

Step S102: Split a emitted beam transmitted by the laser transceiver assembly into the parallel emitted beams transmitted along a predetermined first direction and located in the same plane.

Split a emitted beam transmitted by the laser transceiver assembly 10 to form the parallel emitted beams. In this embodiment, the parallel emitted beams are transmitted along a predetermined first direction and are located in the same plane. That is, the parallel emitted beams are arranged in a linear array. The first direction is the direction from the laser transceiver assembly 10 towards the polygon mirror 21, and both the first direction and the plane are parallel to the first axis X.

In this embodiment, controlling the plurality of beams of emitted light to be transmitted along the predetermined first direction to form the parallel emitted beams located in the same plane is achieved by providing the multi-channel optical circulator 14 in the laser transceiver assembly 10. Specifically, the emitted light passes through the first multi-channel fiber collimator 13 to form the parallel emitted beams located in the same plane. It can be understood that the original beam of light emitted by the laser transmitter 11, i.e., the emitted light, passes through the first multi-channel fiber collimator 13 to form several laser beams, i.e., the parallel emitted beams. The number of laser beams in the parallel emitted beams is the same as the number of channels of the first multi-channel fiber collimator 13.

In this embodiment, there is an angle between adjacent two beams of emitted light in the parallel emitted beams, and the size of the angle can be adjusted according to the spot size and degree of overlap of the emitted light. Specifically, the angle between each emitted beam transmitted by the laser transceiver assembly 10 is less than 0.5°.

Step S104: Control the rotation of the reflecting element and the inversion of the polygon mirror to be synchronous, so that the parallel emitted beams is reflected by the polygon mirror to form reflected emitted light and then emitted out of the LiDAR device, or so that the plurality of beams of reflected beams entering the LiDAR device are reflected by the polygon mirror to form parallel reflected beams located in the plane.

Control the rotation of the reflective assembly 20 and the inversion of the polygon mirror 21 to be synchronous, so that the parallel emitted beams is reflected by the polygon mirror 21 to form reflected emitted light and then emitted out of the LiDAR device 1.

Control the rotation of the reflective assembly 20 and the inversion of the polygon mirror 21 to be synchronous, so that the plurality of beams of reflected beams entering the LiDAR device 1 are reflected by the polygon mirror 21 to form parallel reflected beams located in the plane. The reflected beams are formed by reflection of the reflected emitted light by an object.

In this embodiment, the parallel emitted beams are transmitted along the optical path 100 into the polygon mirror 21 in the upper housing 40. After being reflected by the polygon mirror 21, the parallel emitted beams exit from the window 43 to the outside of the LiDAR device 1. The reflected beams formed after the parallel emitted beams are emitted return to the polygon mirror 21 through the window 43, and the reflected beams are reflected by the polygon mirror 21 to form parallel reflected beams.

Step S106: Receive the parallel reflected beams by the laser transceiver assembly.

The parallel reflected beams return along the optical path to the laser transceiver assembly 10 and are received by the laser transceiver assembly 10.

In this embodiment, the parallel emitted beams are transmitted along the transmitting channels from the second accommodating cavity 500 to the first accommodating cavity 400 and enter the polygon mirror 21. The reflecting surfaces 210 reflect the parallel emitted beams to form reflected emitted light and emit the reflected emitted light from the window 43. When the plurality of beams of reflected beams are incident on the polygon mirror 21 from the window 43, the reflecting surfaces 210 also reflect the plurality of beams of reflected beams to form parallel reflected beams, which are then transmitted from the first accommodating cavity 400 to the second accommodating cavity 500 and received by the laser transceiver assembly 10.

When the laser transceiver assembly receives the parallel reflected beams, control the plurality of beams of parallel reflected beams to be transmitted in a predetermined second direction to form a beam of incoming reflected beams.

In this embodiment, controlling the plurality of beams of parallel reflected beams to be transmitted in a predetermined second direction to form a beam of incoming reflected beams is achieved by the multi-channel optical circulator 14. The multi-channel optical circulator 14 further includes a plurality of beam splitters 141 and a plurality of wave plates 142. The plurality of beam splitters 141 and the plurality of wave plates 142 are arranged in a certain way between the first multi-channel fiber collimator 13 and the second multi-channel fiber collimator 12 to form a plurality of transmitting channels and a plurality of receiving channels. In this embodiment, each transmitting channel and the corresponding receiving channel partially overlap. That is, the transmitting channels and receiving channels are coaxial, thereby achieving matching between the transmitting channels and receiving channels. The beam splitters 141 include but are not limited to polarization beam splitters, depolarized beam splitters, etc., and the wave plates 142 include but are not limited to half-wave plates, quarter-wave plates, etc. The types of beam splitters 141 and wave plates 142 and their arrangement can be set according to the number of laser beams, which is not limited here.

Specifically, after being reflected by the polygon mirror 21, the plurality of beams of parallel reflected beams are refracted by the beam splitters 141 and transmitted in the predetermined second direction, and then pass through the second multi-channel fiber collimator 12 to form incoming reflected beams. The predetermined second direction is different from the predetermined first direction. The number of laser beams in the plurality of beams of parallel reflected beams is the same as the number of channels of the second multi-channel fiber collimator 12.

The parallel emitted beams are transmitted along the transmitting channels into the polygon mirror 21, and the plurality of beams of parallel reflected beams are transmitted along the receiving channels into the second multi-channel fiber collimator 12. It can be understood that the emitted light is emitted from the first multi-channel fiber collimator 13, and the reflected beams are received by the second multi-channel fiber collimator 12. The number of parallel emitted light beams, the number of parallel reflected beams, the number of transmitting channels, and the number of receiving channels are all the same. The the parallel emitted beams are in one-to-one correspondence with the transmitting channels, and the plurality of beams of parallel reflected beams are in one-to-one correspondence with the receiving channels.

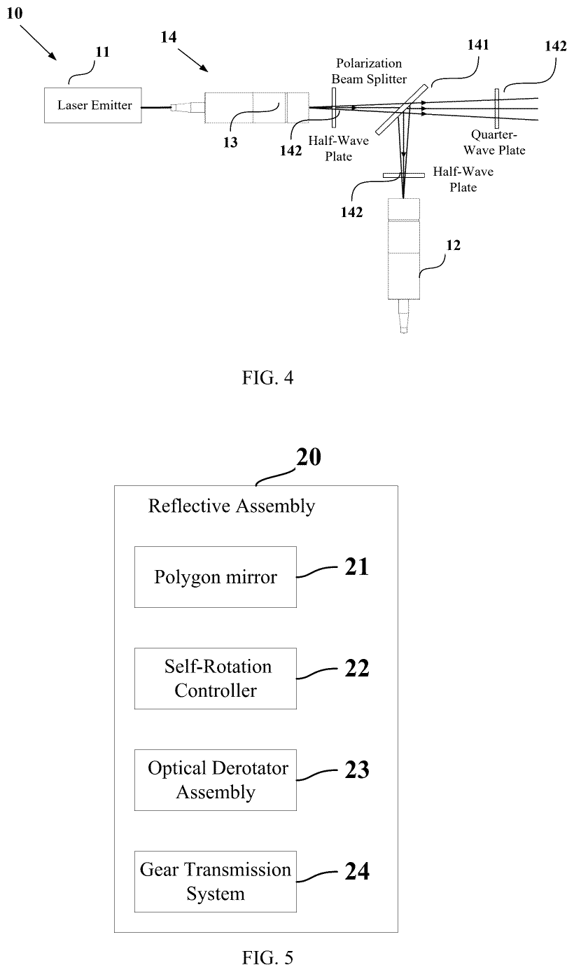

Taking the laser transceiver assembly 10 shown in FIG. 4 as an example, both the first multi-channel fiber collimator 13 and the second multi-channel fiber collimator 12 are three-channel fiber collimators and are arranged perpendicularly. The emitted beam transmitted by the laser transmitter 11 is a frequency-modulated continuous wave with a wavelength band of 1550 nm. The emitted beam passes through the first multi-channel fiber collimator 13 to form three beams of parallel emitted light. The degree of polarization of the three beams of parallel emitted light is greater than 20 dB. The three beams of parallel emitted light are in the same plane, the beam diameter of the parallel emitted beams is 10 mm, and the angle between adjacent two laser beams in the three beams of parallel emitted light is 0.2°. The emitted light of the first channel is deflected by +0.2°, the emitted light of the second channel is not deflected, and the emitted light of the third channel is deflected by −0.2°. Although there is a certain angle between adjacent two laser beams in the three beams of parallel emitted light, since the angle can be adjusted according to the density of the emitted light, and the angle is usually between 0.1° and 0.2°, it does not have a significant impact on the polarization performance of the multi-channel optical circulator 14.

The multi-channel optical circulator 14 includes one polarization beam splitter, two half-wave plates, and one quarter-wave plate. The two half-wave plates correspond to the first multi-channel fiber collimator 13 and the second multi-channel fiber collimator 12 respectively. The two half-wave plates are respectively disposed at the exit of the first multi-channel fiber collimator 13 and the entrance of the second multi-channel fiber collimator 12. The polarization beam splitter is disposed at the intersection of the line where the first multi-channel fiber collimator 13 is located and the line where the second multi-channel fiber collimator 12 is located. The quarter-wave plate is disposed on the side of the polarization beam splitter away from the first multi-channel fiber collimator 13. It can be understood that the first multi-channel fiber collimator 13, the half-wave plate corresponding to the first multi-channel fiber collimator 13, the polarization beam splitter, and the quarter-wave plate are located on the same line and are sequentially arranged along the first axis X; the quarter-wave plate, the polarization beam splitter, the half-wave plate corresponding to the second multi-channel fiber collimator 12, and the second multi-channel fiber collimator 12 are located on the same line and are sequentially arranged in the direction perpendicular to the first axis X. In this embodiment, along the direction away from the first shell 41, the quarter-wave plate, the polarization beam splitter, the half-wave plate corresponding to the first multi-channel fiber collimator 13, and the first multi-channel fiber collimator 13 are sequentially arranged along the first axis X. Along the direction away from the polarization beam splitter, the half-wave plate corresponding to the second multi-channel fiber collimator 12 and the second multi-channel fiber collimator 12 are sequentially arranged in the direction perpendicular to the first axis X. Three transmitting channels are formed between the first multi-channel fiber collimator 13, the half-wave plate corresponding to the first multi-channel fiber collimator 13, the polarization beam splitter, and the quarter-wave plate. Three receiving channels are formed between the quarter-wave plate, the polarization beam splitter, the half-wave plate corresponding to the second multi-channel fiber collimator 12, and the second multi-channel fiber collimator 12. It can be understood that each transmitting channel and the corresponding receiving channel partially overlap between the quarter-wave plate and the polarization beam splitter. It can be understood that the line where the first direction is located is parallel to the first axis X, and the first direction is perpendicular to the second direction.

The three laser beams exit from the first multi-channel fiber collimator 13, pass through the half-wave plate corresponding to the first multi-channel fiber collimator 13, pass through the polarization beam splitter, and then exit from the quarter-wave plate. The three parallel echo beams are incident from the quarter-wave plate. By rotating the quarter-wave plate, the polarization state of the echo beams is rotated to vertical polarization. Then, the echo beams sequentially pass through the polarization beam splitter and the half-wave plate corresponding to the second multi-channel fiber collimator 12 and are incident on the second multi-channel fiber collimator 12.

The diameter of the polarization beam splitter is 12.7 mm, the thickness is 2 mm, the design wavelength is 1550 nm, the dimensional tolerance is +0.1 mm, the surface quality is 60/40, the light transmission aperture is greater than 80%, the transmitted wavefront distortion and reflected wavefront distortion are both not greater than N/8@633 nm, the beam deviation is less than 0.5 minutes, the transmitted extinction ratio is greater than 1000:1, the reflected extinction ratio is greater than 200:1, the splitting surface is coated with a 1550 nm polarized beam splitting dielectric film (PBS), the incident surface is coated with a 1550 nm anti-reflective film, and R<0.25% @1550 nm. In some feasible embodiments, the parameters of the polarization beam splitter can be adjusted according to actual conditions, not limited to this.

When the parallel emitted beams are incident on the polygon mirror 21, the plane where the parallel emitted beams are located is parallel to the first axis X. The polygon mirror 21 rotates about the first axis X while inverting about the second axis Y to reflect the parallel emitted beams, so that the formed reflected emitted light forms a point cloud array.

When the polygon mirror 21 rotates about the first axis X, it reflects the parallel emitted beams to form several first scanning lines around the first axis X. When the polygon mirror 21 inverts about the second axis Y, it reflects the parallel emitted beams to form several second scanning lines around the second axis Y. The several first scanning lines and the several second scanning lines together form a point cloud array. It can be understood that the first scanning lines formed by the reflected emitted light are perpendicular to the first axis X, and the second scanning lines formed by the reflected emitted light are perpendicular to the second axis Y.

In this embodiment, the scanning frequency of the LiDAR device 1 is calculated according to a first formula. The first formula is f_{scan}=ω̅Nₘ, where f_{scan} indicates the scanning frequency, ω̅ indicates the rotation speed of the polygon mirror 21 inverting, i.e., the second rotation speed, and Nₘ indicates the number of faces of the polygon mirror 21, i.e., the number of reflecting surfaces 210.

Specifically, the scanning frequency of the LiDAR device 1 is the scanning frequency of the polygon mirror 21. ω̅ refers to a number of revolutions per second that the polygon mirror 21 inverts 360° about the second axis Y, and f_{scan} refers to the equivalent number of revolutions per second that the polygon mirror 21 inverts 360° about the second axis Y. For example, when ω̅ is 100 revolutions per second and Nₘ is 8, it is equivalent to the polygon mirror 21 inverting 800 revolutions in 1 second.

In this embodiment, the number of scanning lines per frame of the LiDAR device 1 is calculated according to a second formula. The second formula is

$${N}_{p} = \frac{{f}_{scan}}{{f}_{FRAME}} = \frac{ϖ {N}_{m}}{{f}_{FRAME}} ,$$

where Nₚ indicates the number of scanning lines per frame, and f_{FRAME} indicates the frame rate of the LiDAR device 1. The frame rate indicates that the LiDAR device 1 customarily packages several scanning cycles into a data packet for transmission.

In this embodiment, the number of scanning lines in the horizontal direction of the LiDAR device 1 is calculated according to a third formula. The third formula is N=nNₚ, wherein N indicates the number of scanning lines in the horizontal direction of the LiDAR device 1, i.e., the number of first scanning lines of the polygon mirror 21, and n indicates the number of channels of the first multi-channel fiber collimator 13.

Specifically, the number of scanning lines in the horizontal direction of the LiDAR device 1 is the number of first scanning lines of the polygon mirror 21, and the number of first scanning lines is the number of scanning lines in the horizontal direction.

In this embodiment, the number of scanning lines in the vertical direction of the LiDAR device 1 is calculated according to a fourth formula. The fourth formula is

$${N}_{r} = \frac{{f}_{emit} η}{{N}_{p}} ,$$

wherein Nᵣ indicates the number of scanning lines in the vertical direction of the LiDAR device, i.e., the number of second scanning lines of the polygon mirror 21, fₑₘᵢₜ indicates the repetition frequency of the LiDAR device 1, i.e., the repetition frequency of the laser transmitter 11, η indicates the duty cycle, and fₑₘᵢₙ indicates the actual transmitting repetition frequency of the LiDAR device 1, i.e., the actual transmitting repetition frequency of the laser transmitter 11.

Specifically, the number of scanning lines in the vertical direction of the LiDAR device 1 is the number of second scanning lines of the polygon mirror 21, and the number of second scanning lines is the number of scanning lines in the vertical direction.

The point cloud array formed by several first scanning lines and several second scanning lines can be expressed as N pixels×Nᵣ pixels. It can be understood that in the point cloud array, the number of point clouds in the horizontal direction is determined by the number of reflecting surfaces 210, the second rotation speed, and the number of channels of the first multi-channel collimator 13; the number of point clouds in the vertical direction is determined by the repetition frequency and duty cycle of the laser transmitter 11.

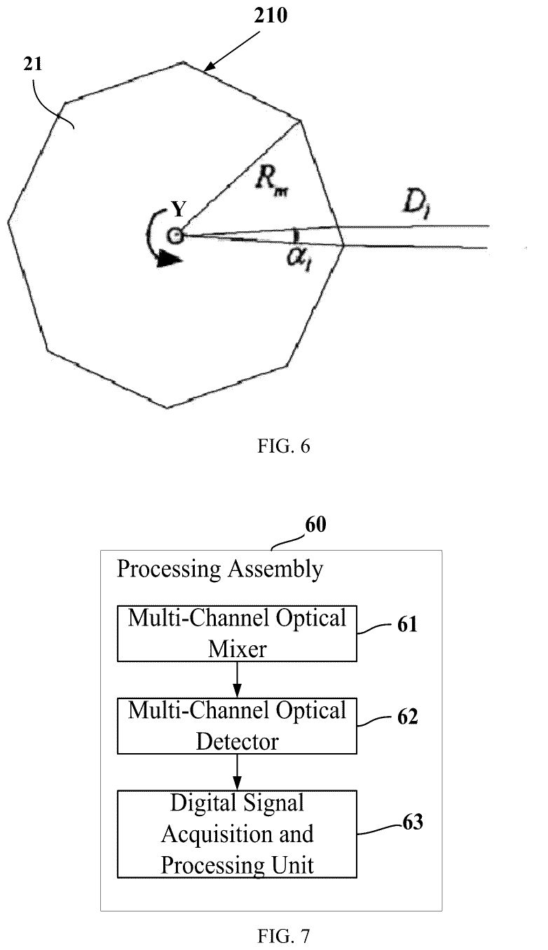

Taking the cross-section of the polygon mirror 21 shown in FIG. 6 as an example, the inscribed radius of the polygon mirror 21 is Rₘ, and the width of the light spot formed on the reflecting surface 210 by the parallel emitted beams is Dₗ.

Assuming that, Dₗ is much smaller than Rₘ the angle αₗ subtended by the the parallel emitted beams at the central axis of the polygon mirror 21 can be calculated according to a fifth formula. Specifically, the fifth formula is

$${α}_{l} = \frac{{D}_{l} \times 180 °}{π {R}_{m}} .$$

The effective rotation angle αᵥ of each reflecting surface 210 can be calculated according to a sixth formula. Specifically, the sixth formula is

$${α}_{v} = {α}_{n} - {α}_{l} = \frac{360 °}{{N}_{m}} - \frac{{D}_{l} \times 180 °}{π {R}_{m}} .$$

wherein Nₘ indicates the number of reflecting surfaces 210, and an indicates the angle subtended by the reflecting surface 210 at the central axis.

The effective field of view angle formed when the reflected emitted light is reflected by the reflecting surface 210 and exits from the window 43, i.e., the vertical field of view angle of the LiDAR device 1, can be calculated according to a seventh formula. Specifically, the seventh formula is

$${θ}_{v} = \frac{720 °}{{N}_{m}} - \frac{{D}_{l} \times 360 °}{π {R}_{m}} .$$

Therefore, the vertical angular resolution of the LiDAR device 1 is

$$\frac{{θ}_{v}}{{N}_{r}} .$$

Since the turntable controller 32 controls the turntable 31 to rotate 360°, the horizontal field of view angle of the LiDAR device 1 is 360°. Therefore, the horizontal angular resolution of the LiDAR device 1 is

$$\frac{360 °}{N} .$$

For example, if the number of Nₘ reflecting surfaces 210 of the polygon mirror 21 is 8, the second rotation speed of the polygon mirror 21 is 6000 RPM, i.e., w 100 revolutions per second, then the scanning frequency f_{scan} is 800 Hz. If the frame rate f_{FRAME} of the LiDAR device 1 is 10 Hz, then the number Ng of the scanning lines per frame is 80. If the number of channels of the first multi-channel fiber collimator 13 is 3, then the number N of first scanning lines is 240. If the repetition frequency fₑₘᵢₜ of the laser transmitter 11 is 200 kHz, i.e., the laser transmitter 11 emits 200,000 times per frame, and the duty cycle n is 80%, then the laser transmitter 11 actually emits 160,000 times per frame, and the number of second scanning lines Nᵣ is 2000. Therefore, the point cloud array formed by the first scanning lines and the second scanning lines is 240 pixels×2000 pixels. Correspondingly, the horizontal field of view angle is 360°, and the horizontal angular resolution is 1.5°. If the inscribed radius Rₘ of the polygon mirror 21 is 100 mm, then the vertical field of view angle θᵥ is about 50°, and the vertical angular resolution is 0.025°.

Referring to FIG. 5, which is a schematic diagram of the internal structure of the reflecting element in accordance with an embodiment. After controlling the plurality of beams of emitted light to be transmitted along the predetermined first direction to form parallel emitted light located in the same plane, image rotation compensation is performed on the parallel emitted beams. In this embodiment, image rotation compensation for the parallel emitted beams is achieved by an optical derotator assembly 23 disposed in the reflective assembly 20.

Specifically, the optical derotator assembly 23 is disposed on the optical path 100 between the laser transceiver assembly 10 and the polygon mirror 21. It can be understood that before the parallel emitted beams are incident on the polygon mirror 21, they need to pass through the optical derotator assembly 23, which is used for image rotation compensation. The optical derotator assembly 23 is rotatable about the first axis X. The speed at which the optical derotator assembly 23 rotates about the first axis X is adapted to the speed at which the polygon mirror 21 rotates about the first axis X. In this embodiment, the speed at which the optical derotator assembly 23 rotates about the first axis X can be half of the speed at which the polygon mirror 21 rotates about the first axis X. For example, if the first rotation speed is 3600°/s, then the rotation speed of the optical derotator assembly 23 is 1800°/s. In some feasible embodiments, the relationship between the rotation speed of the optical derotator assembly 23 about the first axis X and the rotation speed of the polygon mirror 21 about the first axis X can also be set according to actual conditions, which is not limited here.

In this embodiment, the optical derotator assembly 23 is a Pechan prism. For example, the optical derotator assembly 23 is made of Schott glass, model SF11 flint glass material. The refractive index of the optical derotator assembly 23 in the 1550 nm band reaches 1.74, and 1550 nm anti-reflective coatings are plated on the two non-totally reflecting surfaces. The width of the optical derotator assembly 23 is 15 mm, and the height is 20 mm. In some feasible embodiments, the parameters of the optical derotator assembly 23 can be adjusted according to actual conditions, not limited to this.

The reflective assembly 20 further includes a gear transmission system 24, which is connected to the polygon mirror 21 and the optical derotator assembly 23 respectively. When the polygon mirror 21 rotates about the first axis X, the polygon mirror 21 drives the gear transmission system 24 to operate, and the gear transmission system 24 drives the optical derotator assembly 24 to rotate about the first axis X.

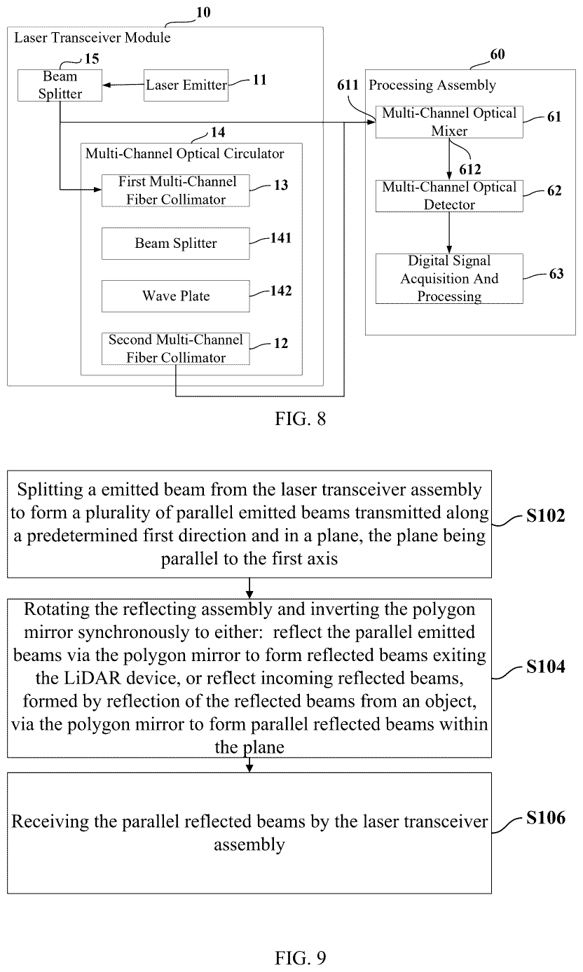

Referring to FIGS. 7 and 8, FIG. 7 is a schematic diagram of the internal structure of the processing assembly in accordance with an embodiment, and FIG. 8 is a diagram showing the connection relationship between the processing assembly and the laser transceiver assembly in accordance with an embodiment. The LiDAR device 1 further includes a processing assembly 60. The processing assembly 60 is accommodated in the second accommodating cavity 500 and is electrically connected to the laser transceiver assembly 10. The processing assembly 60 is used to process the emitted beam and the incoming reflected beams to form point cloud data.

The processing assembly 60 includes a multi-channel optical mixer 61, a multi-channel optical detector 62, and a digital signal acquisition and processing unit 63, which are sequentially connected. The multi-channel optical mixer 61 is connected to the multi-channel optical detector 62, and the multi-channel optical detector 62 is connected to the digital signal acquisition and processing unit 63.

The multi-channel optical mixer 61 collects the emitted beam emitted by the laser transmitter 11 and the incoming reflected beams received and formed by the second multi-channel fiber collimator 12, and performs coherent mixing of the emitted beam and the incoming reflected beams to obtain mixed optical beams. The multi-channel optical detector 62 converts the mixed optical beams into corresponding electrical signals.

The digital signal acquisition and processing unit 63 is further connected to the self-rotation controller 22 and the turntable controller 32 respectively. The digital signal acquisition and processing unit 63 processes the electrical signals and combines data such as the inversion angle of the polygon mirror 21 fed back by the self-rotation controller 22 and the rotation angle of the turntable 31 fed back by the turntable controller 32 to obtain point cloud data.

In this embodiment, the laser transceiver assembly 10 further includes a beam splitter 15, which is disposed between the laser transmitter 11 and the first multi-channel fiber collimator 13. The multi-channel optical mixer 61 includes a receiving end 611 and an output end 612. The receiving end 611 of the multi-channel optical mixer 61 is connected to the beam splitter 15 and the second multi-channel fiber collimator 12 respectively, and the output end 612 of the multi-channel optical mixer 62 is connected to the multi-channel optical detector 62. It can be understood that the beam splitter 15 splits the emitted beam emitted by the laser transmitter 11 into two paths. One path of the light beams is incident on the first multi-channel fiber collimator 13 to form the parallel emitted beams, and the other path of the light beams is incident on the receiving end 611 of the multi-channel optical mixer.

The LiDAR device 1 further includes a power supply assembly 70 and a communication assembly 80. The power supply assembly 70 and the communication assembly 80 can be accommodated in the first accommodating cavity 400, can be accommodated in the second accommodating cavity 500, and can also be disposed in the connecting neck 90 between the first shell 41 and the second shell 51. In this embodiment, the power supply assembly 70 and the communication assembly 80 are disposed in the connecting neck 90. The power supply assembly 70 is connected to the communication assembly 80 and the self-rotation controller 22 respectively, and is used to provide power to the communication assembly 80 and the self-rotation controller 22. The communication assembly 80 is communicatively connected to the self-rotation controller 22, the turntable controller 32, and the processing assembly 60 respectively, and is used to provide data communication. In this embodiment, the power supply assembly 70 is a wireless power supply device, and the communication assembly 80 is a wireless communication device. In some feasible embodiments, the power supply assembly 70 can also be connected to the laser transceiver assembly 10, the actuator mechanism 30, or the processing assembly 60, etc., to provide power to the laser transceiver assembly 10, the actuator mechanism 30, or the processing assembly 60.

In the above embodiments, a emitted beam is split to form the parallel emitted beams. Through cooperation between the reflecting element rotatable about the first axis and the polygon mirror invertible about the second axis, when the parallel emitted beams is incident on the polygon mirror, the polygon mirror reflects the parallel emitted beams along the first axis and the second axis by rotating about the first axis while inverting about the second axis, thereby achieving multi-line scanning. The polygon mirror can achieve 360° circumferential scanning of the LiDAR device by rotating 360° about the first axis while inverting 360° about the second axis, forming a 360° point cloud array. Based on the emitted beam and the incoming reflected beams, and synchronized with the angles of rotation and inversion of the polygon mirror, 360° point cloud data can be obtained. The overall structure of the LiDAR device breaks through the constraints of the traditional upper and lower housing structure configuration of multi-line LiDAR devices, making it applicable to LiDAR devices of different systems including non-coherent and coherent systems. It has a small moment of inertia, simple structure, high reliability, and easy integration and miniaturization, showing good development prospects in the field of vehicle-mounted LiDAR devices.

It is apparent to those skilled in the art that various modifications and variations can be made to the disclosure without departing from the spirit and scope of the disclosure. Therefore, if these modifications and variations of the disclosure fall within the scope of the claims of the disclosure and their equivalent technologies, the disclosure also intends to include these modifications and variations.

The above-listed embodiments are merely preferred embodiments of the disclosure and cannot be used to limit the scope of the disclosure. Therefore, equivalent changes made according to the claims of the disclosure still fall within the scope encompassed by the disclosure.

1. A circumferential scanning method for a LiDAR device, the LiDAR device comprising a laser transceiver assembly and a reflecting element including a polygon mirror, the laser transceiver assembly being configured to transmit and receive laser beams, the reflecting element being rotatable about a first axis, and the polygon mirror being invertible about a second axis, the first axis and the second axis being perpendicular to each other, and an optical path of the laser transceiver assembly passing through the polygon mirror; the circumferential scanning method comprising:
splitting a emitted beam from the laser transceiver assembly to form a plurality of parallel emitted beams transmitted along a predetermined first direction and in a plane, the plane being parallel to the first axis;
rotating the reflecting element and inverting the polygon mirror synchronously to either:
reflect the parallel emitted beams via the polygon mirror to form reflected beams exiting the LiDAR device, or
reflect incoming reflected beams, formed by reflection of the reflected beams from an object, via the polygon mirror to form parallel reflected beams within the plane; and
receiving the parallel reflected beams by the laser transceiver assembly.

2. The circumferential scanning method according to claim 1, wherein adjacent emitted beams from the laser transceiver assembly form an angle between each two less than 0.5°.

3. The circumferential scanning method according to claim 1, wherein splitting a emitted beam from the laser transceiver assembly to form a plurality of parallel emitted beams transmitted along a predetermined first direction and in a plane, the plane being parallel to the first axis implemented by:
a multi-channel optical circulator includes a first multi-channel fiber collimator, wherein the emitted beams passes through the first multi-channel fiber collimator to form the plurality of parallel emitted beams in the plane.

4. The circumferential scanning method according to claim 3, further comprises:
when the laser transceiver assembly receives the parallel reflected beams, controlling the plurality of the parallel reflected beams to transmit in a predetermined second direction so that the parallel reflected beams form the incoming reflected beams.

5. The circumferential scanning method according to claim 4, wherein controlling the plurality of the parallel reflected beams to transmit in a predetermined second direction so that the parallel reflected beams form the incoming reflected beams is implemented by: the multi-channel optical circulator providing a second multi-channel fiber collimator, wherein the plurality of the parallel reflected beams passes through the second multi-channel fiber collimator to form the incoming reflected beams.

6. The circumferential scanning method according to claim 1, further comprises:
performing real-time image rotation compensation on the parallel emitted beams via active mirror control.

7. The circumferential scanning method according to claim 6, wherein the image rotation compensation is implemented by:
an optical derotator assembly mounted on the reflecting element and positioned in an optical path between the laser transceiver assembly and the polygon mirror, wherein the optical derotator assembly is rotatable about the first axis at a speed synchronized with a rotation speed of the polygon mirror about the first axis.

8. The circumferential scanning method according to claim 5, further comprising:
calculating a scanning frequency of the LiDAR device according to a first formula, wherein the first formula is f_{scan}=ω̅Nₘ, f_{scan} indicates the scanning frequency, ω̅ indicates a rotation speed of the polygon mirror inversion, and Nₘ indicates a number of faces of the polygon mirror.

9. The circumferential scanning method according to claim 8, further comprises:
calculating a number of scanning lines per frame of the LiDAR device according to a second formula, wherein the second formula is
$${N}_{p} = \frac{{f}_{scan}}{{f}_{FRAME}} = \frac{ϖ {N}_{m}}{{f}_{FRAME}} ,$$
Nₚ indicates the number of scanning lines per frame, and f_{FRAME} indicates a frame rate of the LiDAR device.

10. The circumferential scanning method according to claim 9, further comprising:
calculating a number of scanning lines in a horizontal direction of the LiDAR device according to a third formula, wherein the third formula is N=nNₚ, N indicates the number of scanning lines in the horizontal direction of the LiDAR device, and η indicates a number of channels of the first multi-channel fiber collimator; and
calculating a number of scanning lines in a vertical direction of the LiDAR device according to a fourth formula, wherein the fourth formula is
$${N}_{r} = \frac{{f}_{emit} η}{{N}_{p}} ,$$
Nᵣ indicates the number of scanning lines in the vertical direction of the LiDAR device, fₑₘᵢₜ indicates a repetition frequency of the LiDAR device, η indicates a duty cycle, and fₑₘᵢₜη indicates an actual transmitting repetition frequency of the LiDAR device.

11. A circumferential scanning method for a LiDAR device, the LiDAR device comprising:
a laser transceiver assembly, configured to transmit and receive laser beams; and
a reflecting element, including a polygon mirror through which an optical path of the laser transceiver assembly passes;
wherein, the circumferential scanning method comprising:
splitting an emitted beam from the laser transceiver assembly into a plurality of parallel emitted beams propagating along a predetermined first direction in a plane parallel to a first axis;
synchronously rotating the reflecting element about the first axis, and inverting the polygon mirror about a second axis perpendicular to the first axis, in order to either:
reflect the parallel emitted beams via the polygon mirror as outgoing beams, or
reflect incoming beams, formed by reflection of the outgoing beams from an object, via the polygon mirror as parallel reflected beams in the plane; and
receiving the parallel reflected beams at the laser transceiver assembly.

12. The circumferential scanning method according to claim 11, wherein adjacent emitted beams from the laser transceiver assembly form an angle between each two less than 0.5°.

13. The circumferential scanning method according to claim 11, wherein splitting a emitted beam from the laser transceiver assembly to form a plurality of parallel emitted beams transmitted along a predetermined first direction and in a plane, the plane being parallel to the first axis implemented by:
a multi-channel optical circulator includes a first multi-channel fiber collimator, wherein the emitted beams passes through the first multi-channel fiber collimator to form the plurality of parallel emitted beams in the plane.

14. The circumferential scanning method according to claim 13, further comprises:
when the laser transceiver assembly receives the parallel reflected beams, controlling the plurality of the parallel reflected beams to transmit in a predetermined second direction so that the parallel reflected beams form the incoming reflected beams.

15. The circumferential scanning method according to claim 14, wherein controlling the plurality of the parallel reflected beams to transmit in a predetermined second direction so that the parallel reflected beams form the incoming reflected beams is implemented by: the multi-channel optical circulator providing a second multi-channel fiber collimator, wherein the plurality of the parallel reflected beams passes through the second multi-channel fiber collimator to form the incoming reflected beams.

16. The circumferential scanning method according to claim 11, further comprises: performing real-time image rotation compensation on the parallel emitted beams via active mirror control.

17. The circumferential scanning method according to claim 16, wherein the image rotation compensation is implemented by:
an optical derotator assembly mounted on the reflecting element and positioned in an optical path between the laser transceiver assembly and the polygon mirror, wherein the optical derotator assembly is rotatable about the first axis at a speed synchronized with a rotation speed of the polygon mirror about the first axis.

18. The circumferential scanning method according to claim 15, further comprising:
calculating a scanning frequency of the LiDAR device according to a first formula, wherein the first formula is f_{scan}=ω̅Nₘ, f_{scan} indicates the scanning frequency, ω̅ indicates a rotation speed of the polygon mirror inversion, and Nₘ indicates a number of faces of the polygon mirror.

19. The circumferential scanning method according to claim 18, further comprises:
calculating a number of scanning lines per frame of the LiDAR device according to a second formula, wherein the second formula is
$${N}_{p} = \frac{{f}_{scan}}{{f}_{FRAME}} = \frac{ϖ {N}_{m}}{{f}_{FRAME}} ,$$
Nₚ indicates the number of scanning lines per frame, and f_{FRAME} indicates a frame rate of the LiDAR device.

20. The circumferential scanning method according to claim 19, further comprising:
calculating a number of scanning lines in a horizontal direction of the LiDAR device according to a third formula, wherein the third formula is N=nNₚ, N indicates the number of scanning lines in the horizontal direction of the LiDAR device, and η indicates a number of channels of the first multi-channel fiber collimator; and
calculating a number of scanning lines in a vertical direction of the LiDAR device according to a fourth formula, wherein the fourth formula is
$${N}_{r} = \frac{{f}_{emit} η}{{N}_{p}} ,$$
Nᵣ indicates the number of scanning lines in the vertical direction of the LiDAR device, fₑₘᵢₜ indicates a repetition frequency of the LiDAR device, η indicates a duty cycle, and fₑₘᵢₜ indicates an actual transmitting repetition frequency of the LiDAR device.
